(19) United States
(12) Patent Application Publication
(10) Pub. No.: US 2013/0026331 A1
(43) Pub. Date: Jan. 31, 2013

(54) MOUNTING BRACKET FOR ANTENNA

(71) Applicant: HARADA INDUSTRY CO., LTD., Tokyo (JP)

(72) Inventor: Akiyoshi KODAKA, Konosu-shi (JP)

(73) Assignee: HARADA INDUSTRY CO., LTD., Tokyo (JP)

(21) Appl. No.: 13/632,446

(22) Filed: Oct. 1, 2012

Related U.S. Application Data
(63) Continuation of application No. PCT/JP2011/054703, filed on Mar. 2, 2011.

(30) Foreign Application Priority Data
Mar. 29, 2010 (JP) 2010-075288

(51) Int. Cl. H01Q 1/12

(52) U.S. Cl. 248/534

(57) ABSTRACT

A plurality of projections of which leading edge is sharp is formed on an outer edge on a flat-plate shaped base plate of a mounting bracket. A washer formed with a plurality of protruding tips of which a leading edge is sharp at its upper rim is integrally formed at a substantially center portion of the base plate so as to protrude downward. A nut is rotatably mounted at a bottom portion of the washer. A frame of an antenna device has a shark-fin shape. A protruding screw protrudes from a bottom surface of an antenna base. When the nut of the mounting bracket is tightened to the protruding screw, a plurality of projection and the plurality of protruding tips sticks into a roof. This provides an antenna mounting bracket that does not wobble even if a shark-fin type vehicle antenna is mounted to a curved vehicle panel.

### CROSS-REFERENCE TO RELATED APPLICATION

This application is a U.S. continuation application filed under 35 USC 111 (a) claiming benefit under 35 USC 120 and 365 (c) of PCT application JP2011/054703, filed on Mar. 2, 2011, the entire contents of which are incorporated herein by reference.

### FIELD

The present invention relates to a mounting bracket for an antenna for securing an onboard antenna onto a carbody panel having a curved surface.

### BACKGROUND

Such a mounting bracket for an antenna is disclosed in, for example, Japanese Patent Application Laid-Open No. 2004-23227 and Japanese Patent Application Laid-Open No. 2001-36315.

FIGS. 20 through 23 show a structure of a conventional mounting bracket 100 for securing a vehicle antenna onto a carbody such as a roof panel or the like of the vehicle. FIG. 20 is a perspective view that shows the structure of the mounting bracket 100 viewed downward, FIG. 21 is a perspective view that shows the structure of the mounting bracket 100 viewed upward, FIG. 22 is a plan view that shows the structure of the mounting bracket 100, and FIG. 23 is a front view that shows the structure of the mounting bracket 100.

As shown in these drawings, in the conventional mounting bracket 100, a plurality of protruding tips 110b, each having a triangular shape, are formed on an upper end of a washer 110a formed into a cylindrical shape of which vertical cross section is in a U-letter shape. A nut 111 is rotatably provided at a bottom portion of the washer 110a. In this structure, a ring-shaped protruding portion is formed on the upper surface of the nut 111 having a hexagonal shape, and this ring-shaped protruding portion is inserted into a through hole 110c from downside of the washer 110a, and then the ring-shaped protruding portion is caulked so as to have a widened diameter. Thus, the ring-shaped protruding portion with the widened diameter is engaged with an inner flange portion formed at the lower surface of the washer 110a, so that the nut 111 is rotatably secured at the bottom portion of the washer 110a.

This mounting bracket 100 is used for securing an onboard antenna, for example, onto a vehicle roof. In this case, a protruding screw is formed on a lower surface of an antenna base provided at a lower portion of the vehicle antenna so as to protrude downward therefrom. On the roof, a mounting hole to which the protruding screw is inserted is formed. The onboard antenna is mounted on the roof, while the protruding screw inserted into the mounting hole. Then, the mounting bracket 100 is threadedly engaged with the protruding screw that is inserted through the mounting hole to protrude inside the vehicle, from the inside of the vehicle. When the nut 111 of the mounting bracket 100 is tightened to the protruding screw, four protruding tips 110b, each having a sharp triangular shape, formed on the upper rim of the washer 110a stick into the inside of the carbody, so that the antenna base of the onboard antenna is securely grounded to the carbody through the mounting bracket 100.

In recent years, an onboard antenna having an outer shape of a shark-fin shape has been mounted on a roof of a vehicle. Such a shark-fin type onboard antenna has a length of about 160 to 220 mm and a height of about 60 to 70 mm. In the case a shark-fin type onboard antenna is mounted by using a conventional mounting bracket 100, a problem in which the antenna tends to wobble in lateral directions relative to an advancing direction of the vehicle, since a washer 110a of the mounting bracket 100 has a comparatively small round shape and therefore the roof is sandwiched between the antenna base and the mounting bracket 100 within a small area. In particular, since the roof has a curved surface, and since the thickness of a vehicle panel has become thinner and thinner in recent years, the wobbling tends to occur more easily.

In view of this problem, the object of the present invention is to provide a mounting bracket for an antenna that is free from wobbling even when an onboard antenna having a shark-fin shape is mounted onto a carbody panel having a curved surface.

### SUMMARY

A mounting bracket for an antenna in accordance with the present invention is a mounting bracket for an antenna, which is threadedly engaged with a protruding screw of an antenna main body at inside a vehicle panel. Herein, the protruding screw is formed with threads on its outer circumferential face. The mounting bracket is provided with a flat-plate shaped base plate that has a U-letter shape in its cross section, with a plurality of protruding tips, each having a leading end that is sharpened so as to stick into the vehicle panel, formed on an upper end thereof, a washer portion formed at a substantially center portion thereof so as to protrude therefrom, and a plurality of projections, each having a leading end that is sharpened so as to stick into the vehicle panel, formed on an outer edge thereof; and a nut that is rotatably secured at a bottom portion of the washer portion, and threadedly engaged with the threads formed on the outer circumferential surface of the protruding screw. By this structure, when the nut is tightened to the protruding screw, the plurality of protruding tips stick into the vehicle panel, while the plurality of projections stick into the vehicle panel.

### BRIEF DESCRIPTION OF DRAWINGS

FIG. 1 is a perspective view that shows a structure viewed downward of a mounting bracket for an antenna in accordance with one embodiment of the present invention;

FIG. 2 is a perspective view that shows a structure viewed upward of the mounting bracket for an antenna in accordance with the embodiment of the present invention;

FIG. 3 is a plan view that shows the structure of the mounting bracket for an antenna in accordance with the embodiment of the present invention;

FIG. 4 is a front view that shows the structure of the mounting bracket for an antenna in accordance with the embodiment of the present invention;

FIG. 5 is a side view that shows the structure of the mounting bracket for an antenna in accordance with the embodiment of the present invention;

FIG. 6 is a perspective view that shows a structure of a base plate relating to the mounting bracket for an antenna of the present invention;

FIG. 7 is a front view that shows the structure of the base plate relating to the mounting bracket for an antenna of the present invention;

FIG. 8 is a perspective view that shows a structure of a nut relating to the mounting bracket for an antenna of the present invention;

FIG. 9 is a top view that shows the structure of the base plate relating to the mounting bracket for an antenna of the present invention;

FIG. 10 is a front view that shows the structure the base plate relating to the mounting bracket for an antenna of the present invention;

FIG. 11 is an exploded assembly drawing that shows assembling processes of the mounting bracket for an antenna of the present invention;

FIG. 12 is a front view that shows a structure in which an antenna device provided with the mounting bracket for an antenna of the present invention is mounted onto a roof;

FIG. 13 is a top view that shows the structure in which the antenna device provided with the mounting bracket for an antenna of the present invention is mounted onto a roof;

FIG. 14 is a side view that shows the structure in which the antenna device provided with the mounting bracket for an antenna of the present invention is mounted onto a roof;

FIG. 15 is a cross-sectional view taken along line a-a that shows the structure in which the antenna device provided with the mounting bracket for an antenna of the present invention is mounted onto a roof;

FIG. 16 is a cross-sectional view that shows one portion in an enlarged manner of the structure in which the antenna device provided with the mounting bracket for an antenna of the present invention is mounted onto a roof;

FIG. 17 is a side view that shows another structure in which the antenna device provided with the mounting bracket for an antenna of the present invention is mounted onto a roof;

FIG. 18 is a cross-sectional view taken along line a-a that shows the other structure in which the antenna device provided with the mounting bracket for an antenna of the present invention is mounted onto a roof;

FIG. 19 is a cross-sectional view that shows one portion in an enlarged manner of the other structure in which the antenna device provided with the mounting bracket for an antenna of the present invention is mounted onto a roof;

FIG. 20 is a perspective view that shows a structure of a conventional mounting bracket for an antenna viewed from above;

FIG. 21 is a perspective view that shows a structure of the conventional mounting bracket for an antenna viewed upward;

FIG. 22 is a top view that shows the structure of the conventional mounting bracket for an antenna; and

FIG. 23 is a front view that shows the structure of the conventional mounting bracket for an antenna.

### EXPLANATION OF REFERENCE NUMERALS

1 Mounting bracket, 2 Antenna device, 10 Base plate, 10a Washer, 10b Protruding tip, 10c Elongated hole, 10d Projection, 10e Insertion hole, 11 Nut, 11a Hexagonal member, 11b Ring-shaped protruding portion, 11c Through hole, 12 Frame, 13 Roof, 13a Reinforcing member, 14 Antenna base, 14a Protruding screw, 100 Mounting bracket, 110a Washer, 110b Protruding tip, 110c Through hole, 111 Nut

### DESCRIPTION OF INVENTION

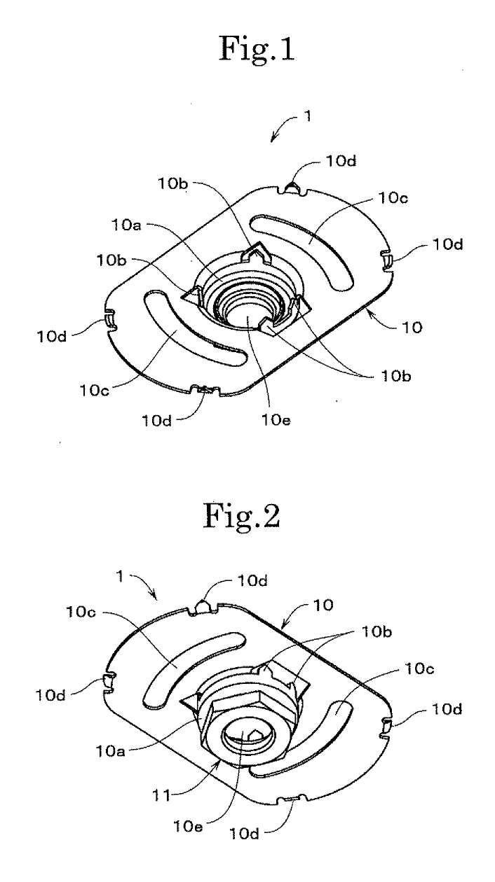

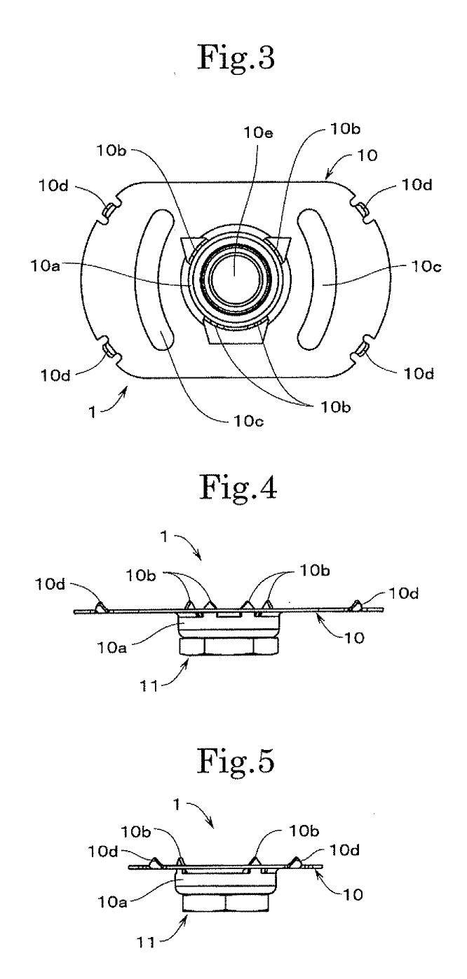

FIGS. 1 through 5 respectively show structures of a mounting bracket 1 for an antenna in accordance with an embodiment of the present invention. FIG. 1 is a downward perspective view that shows the structure of the mounting bracket 1 for an antenna of the embodiment of the present invention, FIG. 2 is an upward perspective view that shows the structure of the mounting bracket 1 for an antenna of the embodiment of the present invention, FIG. 3 is a plan view that shows the structure of the mounting bracket 1 for an antenna of the embodiment of the present invention, FIG. 4 is a front view that shows the structure of the mounting bracket 1 for an antenna of the embodiment of the present invention, and FIG. 5 is a side view that shows the structure of the mounting bracket 1 for an antenna of the embodiment of the present invention.

The mounting bracket 1 for an antenna relating to the embodiment of the present invention shown in these drawings is formed by machining a metal plate, and is constituted by a flat-plate shaped base plate 10, a washer portion 10a formed in the base plate 10 and a nut 11 having a hexagonal shape and made of metal, which is freely rotatably anchored to the washer portion 10a.

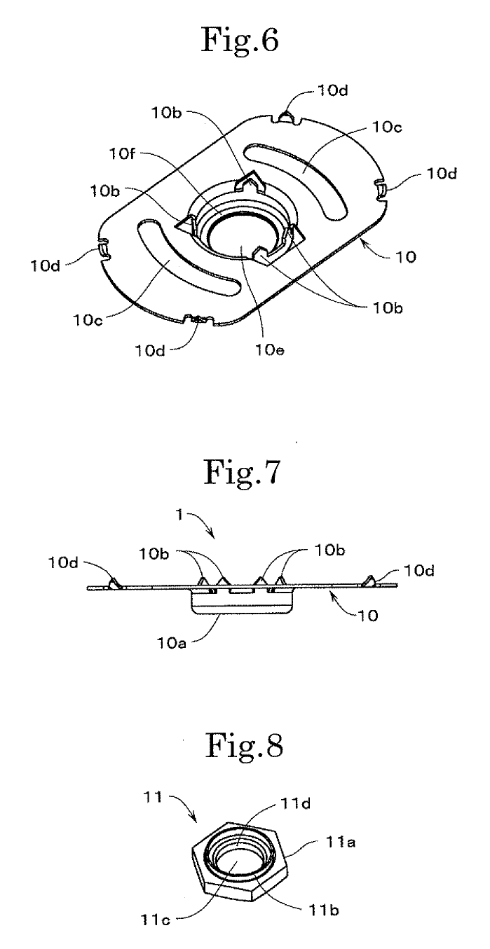

FIGS. 6 and 7 show the structure of the base plate 10 in detail. FIG. 6 is a perspective view showing the structure of the base plate 10 relating to the mounting bracket 1 for an antenna of the embodiment of the present invention, and FIG. 7 is a front view showing the structure of the base plate 10 relating to the mounting bracket 1 for an antenna of the embodiment of the present invention.

As shown in these drawings, the base plate 10 is formed into a substantially oblong shape with its shorter side formed into an arc shape, and the washer portion 10a is formed at a substantially center portion of the base plate 10 so as to protrude downward, by a pressing process. The washer portion 10a is formed into a U-letter shape in its cross-section, with a through hole 10e formed therein, and the lower end of the through hole 10e is narrowed so as to form an inner flange having a ring shape with a narrowed inner diameter. Four sharp protruding tips 10b each having a triangular shape are formed on the upper rim of the through hole 10e of the washer portion 10a so as to protrude upward therefrom. These plural protruding tips 10b are formed so as to protrude upward beyond the upper surface of the base plate 10. In this case, the plural protruding tips 10b are formed by cutting out a border portion between the base plate 10 and the washer portion 10a, and the washer portion 10a is supported to the base plate 10 through the border portion except for the cut-out portions. For this reason, the washer portion 10a is integrally formed in the base plate 10 with elasticity derived from the cutting-out process. At two positions on the shorter sides having an arc shape of the base plate 10 respectively adjacent to boundaries with longer sides, paired projections 10d which are sectioned by cutting grooves on both sides thereof from periphery are formed. Each of the plural projections 10d is also formed into a bent shape so as to protrude upward from the upper surface of the base plate 10. Moreover, on the base plate 10, two arc-shaped elongated holes 10c are formed virtually in parallel with the shorter sides of the periphery of the washer portion 10a.

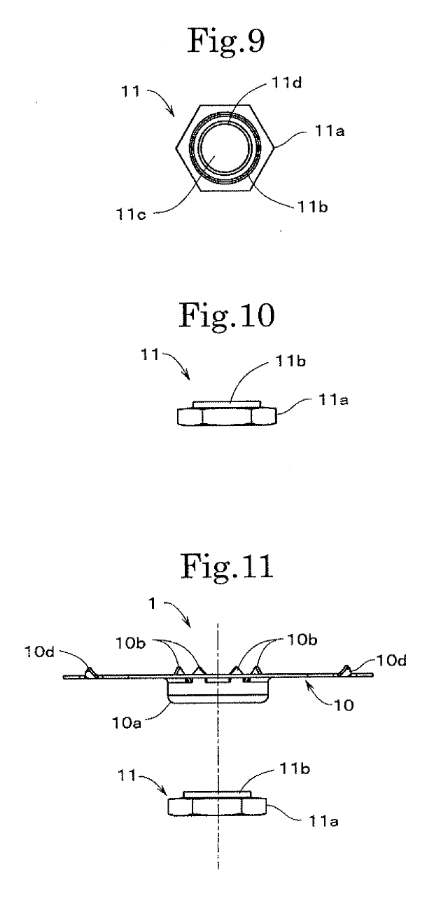

Next, FIGS. 8 through 10 show the structure of the nut 11 in detail. FIG. 8 is a perspective view that shows the structure of the nut 11 relating to the mounting bracket 1 for an antenna of the embodiment of the present invention, FIG. 9 is a plan view that shows the structure of the nut 11 relating to the mounting bracket 1 for an antenna of the embodiment of the present invention, and FIG. 10 is a front view that shows the structure of the nut 11 relating to the mounting bracket 1 for an antenna of the embodiment of the present invention.

As shown in these drawings, the nut 11 is composed of a hexagonal member 10a having a hexagonal shape on which a through hole 11c is formed, and on the upper surface of the hexagonal member 11a, a ring-shaped protruding portion 11b is formed so as to protrude from the upper rim of the through hole 11c. On the inner circumferential surface of the through hole 11c of the hexagonal member 11a, female threads 11d are formed.

FIG. 11 is an exploded assembly drawing that shows assembling processes of the mounting bracket 1 for an antenna of the embodiment of the present invention.

As shown in FIG. 11, the nut 11 is disposed below the base plate 10 so that the ring-shaped protruding portion 11b may face upward. Then, the ring-shaped protruding portion 11b of the nut 11 is inserted into the insertion hole 10e from bottom opening of the washer portion 10a. The ring-shaped protruding portion 11b is subjected to a caulking treatment so that the outer diameter of the ring-shaped protruding portion 11b having inserted through the insertion hole 10e may become wider. Thus, the ring-shaped protruding portion 11b with its diameter widened is engaged with a portion of the lower end of the washer portion 10a whose inner diameter is narrowed to protrude inward with a ring shape, so that the nut 11 is kept so as not to come off the insertion hole 10e, and rotatably anchored to the washer portion 10a.

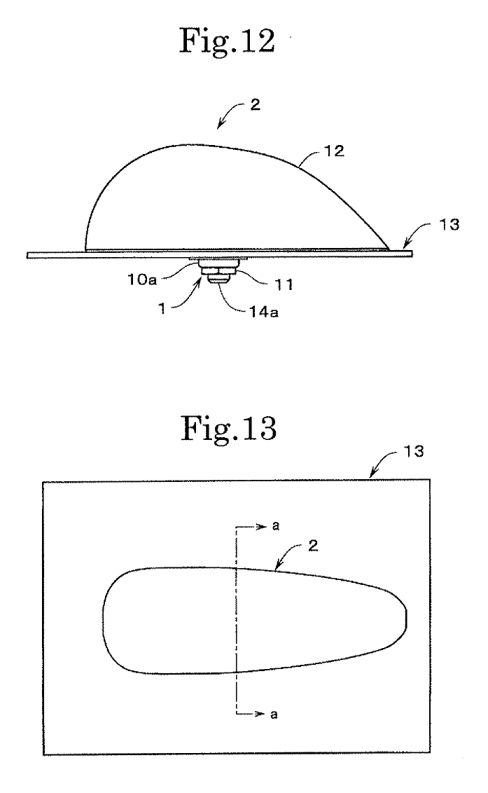

FIGS. 12 and 13 show the outline of the structure of the antenna device 2 that is mounted onto a roof 13 having a curved shape, that is, a vehicle panel, by using the mounting bracket 1 for an antenna in accordance with the embodiment of the present invention, shown in FIGS. 1 through 5, assembled as described above. FIG. 12 is a side view that shows the outline of the structure of the antenna device 2 that is mounted onto the roof 13, and FIG. 13 is a plan view that shows the outline of the structure of the antenna device 2 that is mounted onto the roof 13.

In these drawings, only one portion of the roof 13 is shown. Mounting holes, not shown, are formed through the roof 13 of a vehicle. The antenna 2 is provided with a frame 12 having a shark-fin shape, with an antenna assembly being installed inside the frame 12, and an antenna base 14 made of metal is fixed on the lower surface of the frame 12 so as to close the frame 12. A protruding screw 14a is formed on the lower surface of the antenna base 14 so as to protrude downward therefrom. By inserting the protruding screw 14a into the mounting hole formed through the roof 13, the antenna device 2 is disposed on the roof 13. The protruding screw 14a is exposed inside the carbody through the mounting hole. The protruding screw unit 14a protruding into the carbody is inserted into the insertion hole 10a of the mounting bracket 1 and threadedly engaged with the nut 11. By tightening the nut 11 of the mounting bracket 1, the four projections 10d formed on the outer edge of the base plate 10, each having a sharp triangular shape, stick into the inner surface of the roof 13, while the four protruding tips 10b formed on the upper end of the washer portion 10a, each having a sharp triangular shape, stick into the inner surface of the roof 13. With this structure, the antenna base 14 of the antenna device 2 is securely grounded to the carbody through the mounting bracket 1. Moreover, since the major axis of the base plate 10 is disposed laterally relative to the advancing direction of the vehicle, with the roof 13 being sandwiched between the flat-plate shaped base plate 10 and the antenna base 14, it is possible to prevent the antenna mounting bracket from wobbling when a shark-fin shaped antenna device 2 is mounted onto the roof 13.

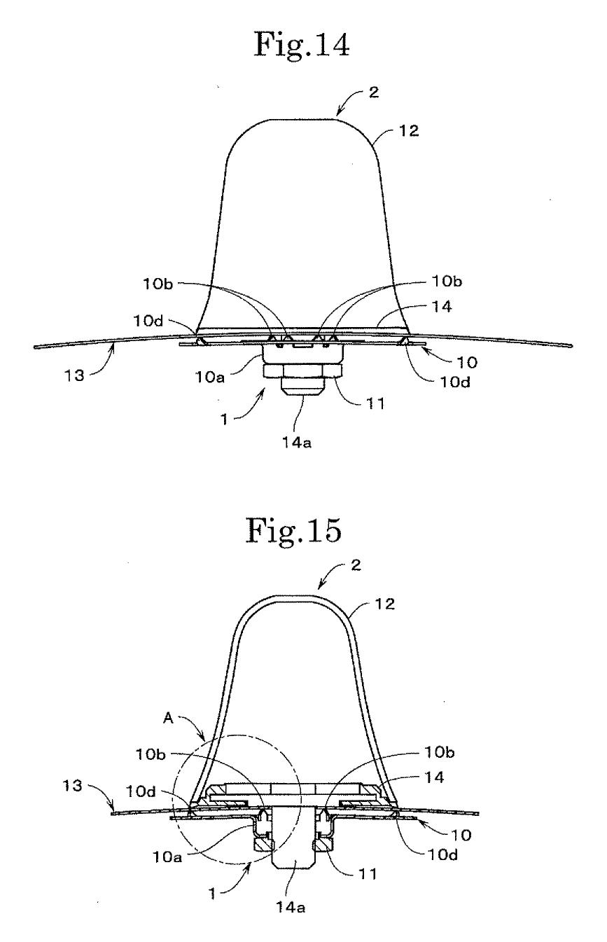

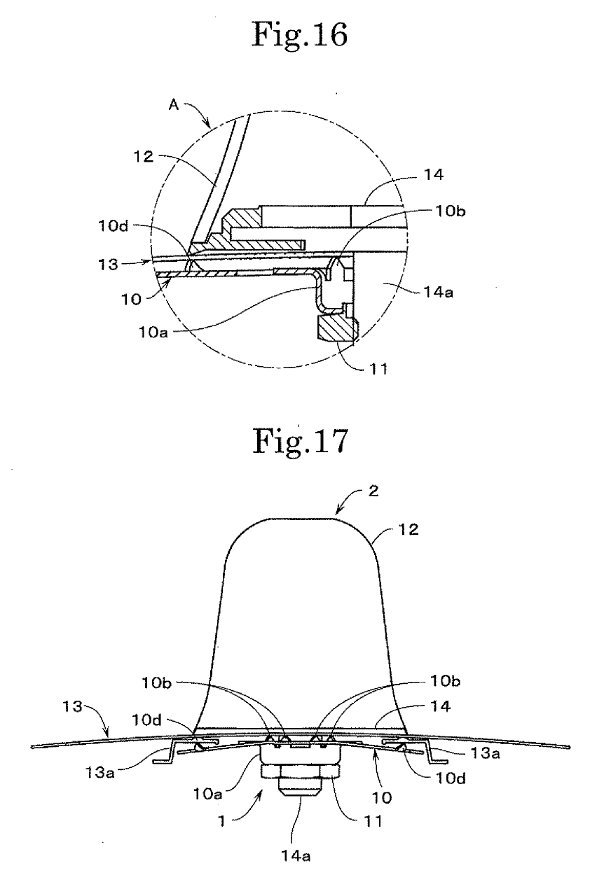

FIGS. 14 through 16 show the structure of the antenna device 2 which is mounted onto the roof 13 with a curved shape that is a vehicle panel by using the mounting bracket 1 for an antenna of the embodiment of the present invention in detail. FIG. 14 is a front view that shows the structure of the antenna device 2 mounted onto the roof 13 in detail, FIG. 15 is a front view that shows a cross section of the structure of the antenna device 2 mounted onto the roof 13 in detail, and FIG. 16 is a cross-sectional view that shows one portion in an enlarged manner of the structure of the antenna device 2 mounted onto the roof 13 in detail.

As shown in these drawings, the lower surface of the frame 12 having a shark-fin shape of the antenna device 2 is closed by the antenna base 14, and the protruding screw 14a protrudes downward from a substantially center portion of the lower surface of the antenna base 14. When the protruding screw 14a is inserted through the insertion hole 10e of the mounting bracket 1 and the nut 11 is fastened to the protruding screw 14a with a spanner or the like, the plural protruding tips 10b formed on the washer portion 10a stick into the bottom surface of the roof 13. At the same time, the plural projections 10d, formed on the outer edge of the flat-plate shaped base plate 10 on the mounting bracket 1 whose major axis is disposed in a direction substantially perpendicular to the advancing direction of the vehicle, stick into the bottom surface of the roof 13.

In this case, the width of the frame 12 of the antenna device 2 is almost same as the interval between the projections 10d formed on the two sides of the base plate 10, so that the antenna device 2 is mounted onto the roof 13 without wobbling. Moreover, since cutout portions for forming the protruding tips 10b are formed at a plurality of places on the border portion between the washer portion 10a and the base plate 10, the base plate 10 is elastically pressed onto the roof 13 when the nut 11 is fastened to the protruding screw 14a. Furthermore, since the base plate 10 is also elastically deformed by the function of the two elongated holes 10c, the antenna device 2 can be securely mounted onto the roof 13 by the mounting bracket 1, even if the roof 13 is formed into a curved surface.

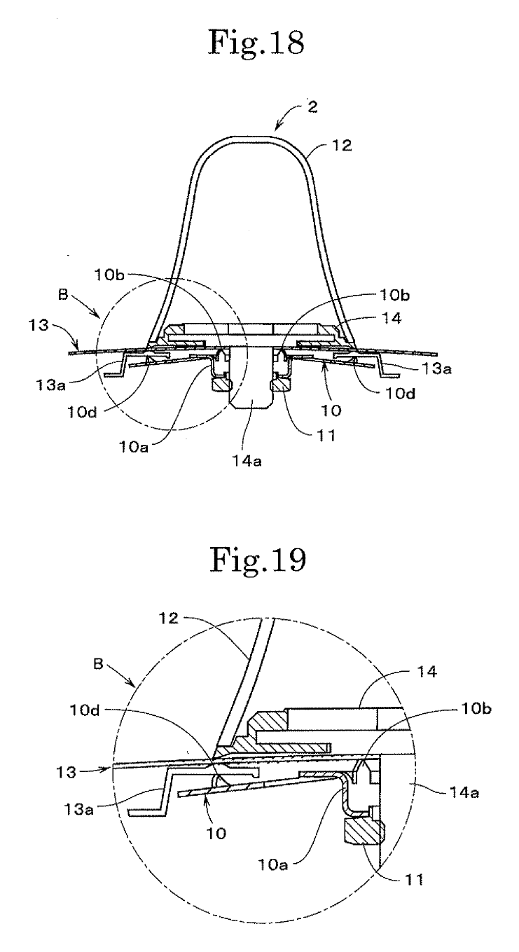

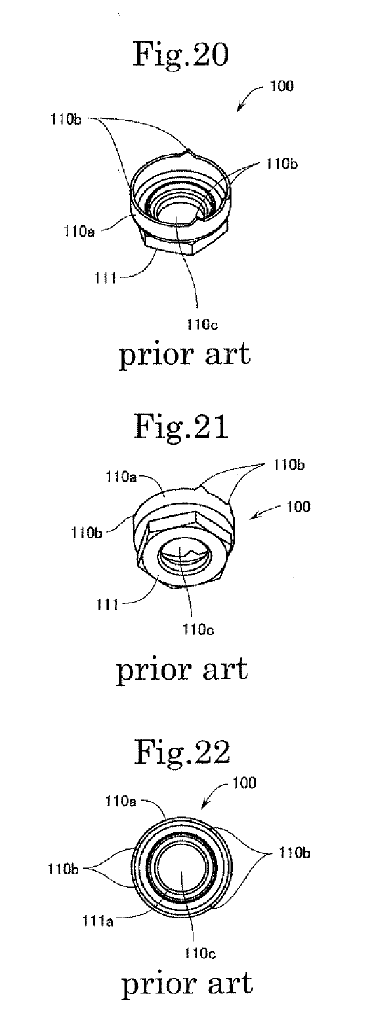

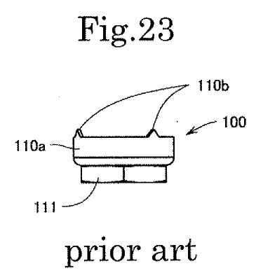

In addition, in recent years, the thickness of the vehicle panel becomes thinner and thinner, and for this reason, a reinforcing member is installed inside the vehicle panel. Therefore, FIGS. 17 through 19 show the detailed structure of the antenna device 2 that is mounted onto the roof 13 as a vehicle panel by the mounting bracket 1 for an antenna of the embodiment of the present invention, in the case when a reinforcing member 13a is installed inside the roof 13. FIG. 17 is a front view that shows a detailed structure of the antenna device 2 mounted onto the roof 13, FIG. 18 is a front view that shows a cross section of the structure of the antenna device 2 mounted onto the roof 13 in detail, and FIG. 19 is a cross-sectional view that shows one portion in an enlarged manner of the detailed structure of the antenna device 2 mounted onto the roof 13.

As shown in these drawings, a plurality of reinforcing members 13a are provided inside the roof 13 of the antenna device 2, and the mounting bracket 1 is disposed in a bridged manner over the reinforcing members 13a. That is, upon fastening the nut 11 of the mounting bracket 1 onto the protruding screw 14a wity a spanner or the like, the plural protruding tips 10b formed on the washer portion 10a stick into the bottom surface of the roof 13, while the plural projections 10d formed on the outer edge of the base plate 10 are placed on the reinforcing members 13a to stick into the same reinforcing members 13a.

In this case, although the plural projections 10d are placed on the reinforcing members 13a, the base plate 10 is elastically deformed by the function of the two elongated holes 10c, so that the antenna device 2 can be securely mounted onto the roof 13 provided with the reinforcing members 13a by the mounting bracket 1. Moreover, since cutout portions for forming the protruding tips 10b are formed at a plurality of points on the border portion between the washer portion 10a and the base plate 10, the base plate 10 is elastically contact onto the roof 13 when the nut 11 is fastened to the protruding screw 14a. With this arrangement, the antenna device 2 can be mounted onto the roof 13 with the reinforcing members 13a provided thereto, without wobbling.

### INDUSTRIAL APPLICABILITY

In the mounting bracket 1 for an antenna in accordance with the present invention as described above, the base plate 10 is formed into an oblong shape; however, this may be formed into a rectangular shape, an elliptical shape, or a round shape. In this case, the number of the projections formed on the outer edge of the base plate 10 is not limited to four, but may be three or five or more. Moreover, the number of the protruding tips 10b formed on the upper rim of the washer portion 10a is not limited to four, but may be three or five or more. Furthermore, the number of the elongated holes 10c formed on the base plate 10 is not limited to two, but four or more of these may be formed.

Besides, although the antenna device has a shark-fin shape, the present invention is not limited by this shape, and as long as the antenna device has a frame having a length of about 160 to 220 mm and a height of about 60 to 70 mm, any shape may be used, and such an antenna device can be mounted onto a carbody panel without wobbling.

In accordance with the present invention, the plural projections, each having a sharp leading edge, are formed on an outer edge of the flat-plate shaped base plate, and upon tightening the nut rotatably provided on the bottom portion of the washer to the protruding screw, the plural protruding tips and the plural projections stick into a vehicle panel, so that an antenna having a shark-fin shape can be mounted onto a vehicle panel having a curved surface without wobbling.

1. A mounting bracket for an antenna, the mounting bracket being threadedly engaged with a male screw of an antenna main body at inside of a vehicle panel, the male screw being formed in a manner so as to protrude from a bottom surface of the antenna main body and inserted into a mounting hole formed through the vehicle panel from outside of the vehicle panel, comprising:
a nut, the nut being threadedly engaged with the male screw; and
a base holding the nut so as to allow the nut only to rotate centered on an axis of a screw hole, the base having a plurality of protruding tips, each of the protruding tips having a sharpen end shape, protruding upward beyond the upper surface of the nut portion, and being located at a plurality of positions surrounding the screw hole at an outside of an outer edge of the nut.

2. The mounting bracket for an antenna according to claim 1, wherein the base is formed of a plate having a through hole co-axial with the screw hole of the nut.

3. The mounting bracket for an antenna according to claim 1, wherein the protruding tips are formed on an edge of the plate.

4. The mounting bracket for an antenna according to claim 1, wherein a portion of the plate is formed into a cylindrical shape by being recessed from one side, the through hole being formed at a center of the cylindrical shaped portion and the nut being held at the opposite side of cylindrical shaped portion.

5. The mounting bracket for an antenna according to claim 4, further comprising:
projections, each having a sharpen end shape, the projections protrude in the same direction as that of the protruding tips, and being located on an edge of the cylindrical shaped portion of the plate.

6. The mounting bracket for an antenna according to claim 4, wherein an elongated hole is formed through the plate at a periphery of the cylindrical shaped portion of the plate.

7. The mounting bracket for an antenna according to claim 1, wherein the base is formed with a hole between a portion holding the nut and the protruding tips.
